(19) United States
(12) Patent Application Publication
(10) Pub. No.: US 2024/0419919 A1
(43) Pub. Date: Dec. 19, 2024

(54) SMART TEXT REWRITING FOR INTERACTIVE DOMAINS

(71) Applicant: Google LLC, Mountain View, CA (US)

(72) Inventors: Rongjing Xiang, Sunnyvale, CA (US); Yue Liang, Sunnyvale, CA (US); Yang Lu, Mountain View, CA (US); Xu Liu, Mountain View, CA (US); Keqian Yan, Shanghai (CN); Jiawei Chen, Mountain View, CA (US)

(21) Appl. No.: 18/238,878

(22) Filed: Aug. 28, 2023

Related U.S. Application Data
(63) Continuation of application No. PCT/CN2023/100975, filed on Jun. 19, 2023.

(51) Int. Cl. G06F 40/40; G06F 40/166; G06F 40/35; G06N 3/08; G06T 11/60

(52) U.S. Cl. CPC G06F 40/40; G06F 40/166; G06F 40/35; G06N 3/08; G06T 11/60

(57) ABSTRACT

The technology provides rewriting suggestions for communication styles in different pre-defined styles. Rewriting may convert text in different ways, including visually enhancing the message. A method provides input to a trained large language model, the input including curated examples associated with one or more writing style choices. The set of curated examples has a first size. The method also includes generating, using the model, a rewriting corpus according to one or more writing style choices. The rewriting corpus has a size two or more orders of magnitude larger than a size of curated examples. The writing style choices include at least one of tone, conversion, application context, or conversation type. A text rewriting model is trained using at least a subset of the rewriting corpus. The model is configured to generate vivid textual information in response to user input in an interactive domain, according to specific writing style choices.

### CROSS-REFERENCE TO RELATED APPLICATIONS

The present application is a continuation of International Application No. PCT/CN2023/100975, filed Jun. 19, 2023, the entire disclosure of which is hereby incorporated by reference.

### BACKGROUND

Effective written communication is important in many areas, including workplace communication, school assignments, emails, social media posts and other types of interactive domains. Large language models (LLMs) have been used for a variety of text-related tasks. In some instances, this has included applying text style transfer to natural language generation. Text style transfer seeks to manage certain attributes in generated text, e.g., humor, emotion or the level of politeness. While such approaches may work satisfactorily in certain general style transfers, such as informal to formal, or formal to informal, there may be clear deficiencies when attempting to transfer writing into more vivid or expressive styles. This could hinder effective communication or otherwise cause confusion, especially when the semantic meaning of the rewritten text is not consistent with the source text.

### BRIEF SUMMARY

The technology relates to computer-implemented systems and methods to provide smart text rewriting in various interactive domains, including but not limited to social media interactions, document editing (e.g., text edits or comments), electronic correspondence, presentations, videoconferencing applications, etc. According to one aspect, a large amount of training data may be generated using a few-shot trained LLM, then applied via a distillation technique to a smaller model. This training data may be domain specific, for instance to produce chat-type data or social media data. A benefit to the smaller model is that it can be implemented directly on a client device, such as a mobile phone, tablet PC, smartwatch or other wearable, etc. The smaller model may even be personalized for a specific user of the client device.

By way of example, the user may be offered one or more rewriting suggestions for different vivid writing styles. This can include rephrasing text into a joking tone, adding emojis to augment (“emojify”) the text, or otherwise personalize the text in a particular way before presentation to a recipient. This can be done with an interactive user interface (UI) or may be performed automatically by the system, such as according to one or more preferences. The approaches and techniques discussed herein can be incorporated into a particular application, which may be run directly on a client device or remotely such as a web app. Alternatively, the approach and techniques may be used as a platform application programming interface (API) for use with third party applications.

According to one aspect of the technology, a computer-implemented method is provided that comprises: providing input to a trained large language model, the input comprising a set of curated examples associated with one or more writing style choices, the set of curated examples having a first size; generating, using the trained large language model, a rewriting corpus according to the one or more writing style choices, the rewriting corpus having a second size two or more orders of magnitude larger than the first size, the one or more writing style choices including at least one of a tone, a conversion, an application context associated with an interactive domain, or a conversation type; storing the rewriting corpus in memory; and training, by one or more processors using at least a subset of the stored rewriting corpus, a text rewriting model that is configured to generate vivid textual information in response to a user input in the interactive domain, according to one or more specific ones of the writing style choices.

Training the text rewriting model may include personalization according to one or more personalized inputs associated with at least one user profile. Here, the training may comprise updating a baseline version of the text rewriting model using the one or more personalized inputs as additional training data for the text rewriting model. The one or more personalized inputs may include conversational context information about a conversation a user has with another person.

The tone may include at least one of casual, formal, humorous, vivid or exaggerated. The conversion may include one of expand an initial amount of text from the user input, abbreviate the initial amount of text, or emojify a text string from the user input. The application context may be associated with a chat domain, a social media domain, an email domain, a word processing domain or a presentation domain. The conversation type may be one of a family conversation, a friends conversation, a dialogue, a colleague interaction, or a business communication.

Alternatively or additionally to any of the above, the text rewriting model may be further trained to generate graphical indicia to emojify the vivid textual information. Here, the trained text rewriting model may be configured to generate one or more patterns of the graphical indicia in response to a concept prediction model or rule-based keyword matching. Alternatively or additionally, emojification of the vivid textual information may be performed according to: using an unsupervised or a semi-supervised approach to detect salient expressive phrases; using a zero-shot or a few-shot learning approach to retrieve a diversified range of emojis that express sentiment and augment semantics; employing logic to utilize model outputs to enable various emojify patterns; or applying evaluation benchmarks to evaluate emojify quality. The trained text rewriting model may be configured to generate one or more patterns of the graphical indicia, the one or more patterns including a beat pattern or an append pattern. The trained text rewriting model may be configured to generate a two-dimensional visualization pattern including at least one emoji or other graphical indicia. The graphical indicia to emojify the vivid textual information may be generated with semantic augmentation. Training the text rewriting model to generate the graphical indicia may include generating a set of emojify annotations, and then training the text rewriting model based on the set of emojify annotations. In this case, generating the set of emojify annotations may include identifying expressive phrase candidates, and then retrieving relevant emojis or other or other graphical indicia for each expressive phrase candidate given the candidate's context in a text segment.

According to another aspect, a computing system is provided that comprises memory configured to store a rewriting corpus, and one or more processors operatively coupled to the memory. The one or more processors are configured to: provide input to a trained large language model, the input comprising a set of curated examples associated with one or more writing style choices, the set of curated examples having a first size; generate, using the trained large language model, the rewriting corpus according to the one or more writing style choices, the rewriting corpus having a second size two or more orders of magnitude larger than the first size, the one or more writing style choices including at least one of a tone, a conversion, an application context associated with an interactive domain, or a conversation type; store the rewriting corpus in memory; and train, using at least a subset of the stored rewriting corpus, a text rewriting model that is configured to generate vivid textual information in response to a user input in the interactive domain, according to one or more specific ones of the writing style choices.

Training the text rewriting model may include personalization according to one or more personalized inputs associated with at least one user profile. Here, the training may comprise updating a baseline version of the text rewriting model using the one or more personalized inputs as additional training data for the text rewriting model. Alternatively or additionally, the text rewriting model may be further trained to generate graphical indicia to emojify the vivid textual information.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-B illustrate an example text rewriting system in accordance with aspects of the technology.

FIG. 2 illustrates a Transformer-type architecture for use in accordance with aspects of the technology.

FIGS. 3A-B illustrate examples of training and using a text rewriting system in accordance with aspects of the technology.

FIGS. 4A-E illustrate emojification examples in accordance with aspects of the technology.

FIG. 5 illustrates an emojification approach in accordance with aspects of the technology.

FIG. 6 illustrates an example phrase detection procedure in accordance with aspects of the technology.

FIG. 7 illustrates an example for sequence label modeling in accordance with aspects of the technology.

FIGS. 8A-B illustrate model architectures for sequence labeling tasks in accordance with aspects of the technology.

FIGS. 9A-B illustrate a system for use with aspects of the technology.

FIG. 10 illustrates an example method in accordance with aspects of the technology.

### DETAILED DESCRIPTION

The technology provides rewriting suggestions for various communication styles, which can be applied in different types of communication domains, from interactive message apps to email to document editing and commenting. One aspect enables a simple but powerful user interface to perform rewriting in one of a number of pre-defined styles. Another aspect enables the system to personalize the style according to a user's own tones (such as casual, vivid, humorous, exaggerated, formal, etc.), depending on the context of the situation. The rewriting may convert the text in different ways, such as to expand on a few words, abbreviate a long text sequence such as a paragraph, or to emojify in order to visually enhance the user's message.

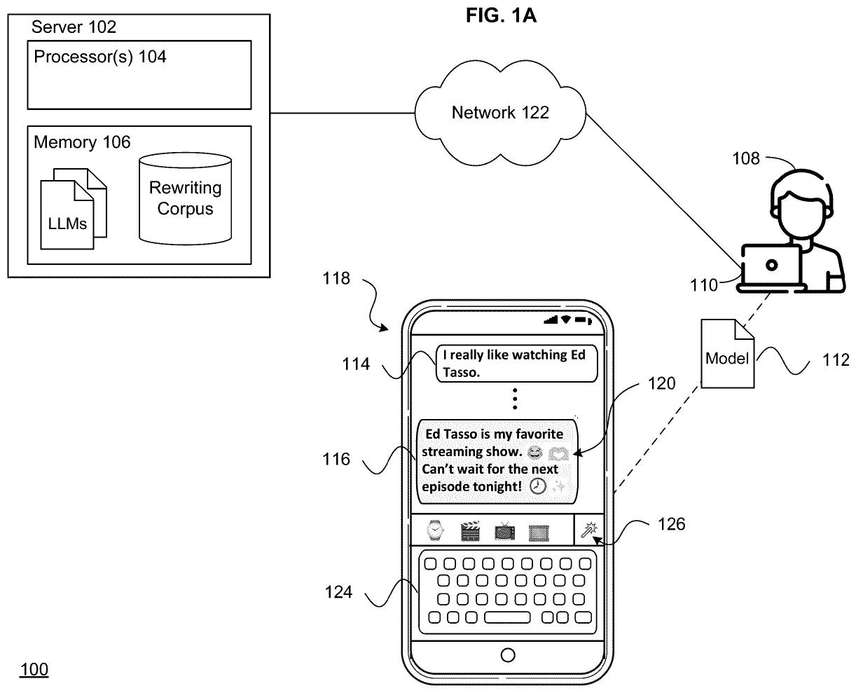

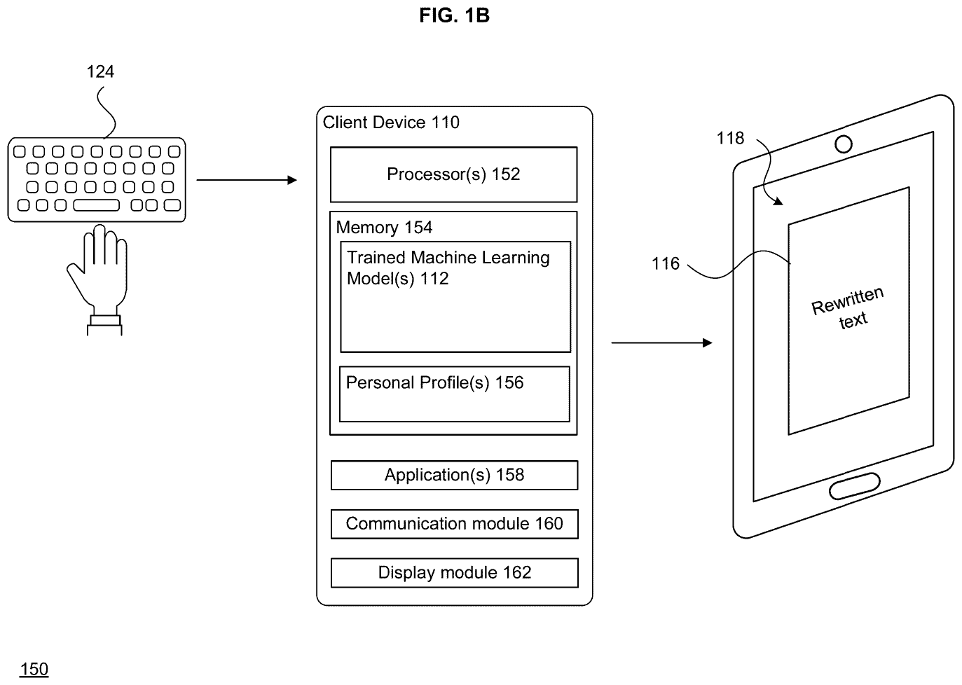

FIGS. 1A-B illustrate one example of this approach. In particular, FIG. 1A illustrates an example involving a system 100 for processing user input and generating one or more rewritten text options. The system 100 may include a server 102 having one or more processors 104 and memory 106 for storing data. In one example, the memory 106 may store one or more trained large language models (LLMs) and/or a rewriting corpus. A user 108 can formulate an initial text segment or other text-related input on their client device 110, which may be, e.g., a laptop or desktop computer, a tablet PC, a mobile phone or PDA, a smartwatch or other wearable computing device, a smart home appliance, etc. The input is processed according to a trained rewriting model 112 to generate the rewritten text options. As discussed in detail below, the model 112 is trained based upon the rewriting corpus, which may be generated by the LLM(s).

For instance, the user may provide text input 114 (e.g., “I really like watching Ed Tasso”). Based on the trained rewriting model 112, the system generates rewritten text 116 and presents it to the user in GUI 118 of the client device 110. The rewriting may include one or more emojis, icons, gifs or other visual (graphical) indicia 120 to emojify the text. The model 112 may be maintained locally by the client device 110 or run by the server 102, with information exchanged between these devices via a network 122. In this example, the user may input the text 114 via a virtual keyboard or other user input 124 (e.g., speech to text), which may be part of the GUI 118. In other examples, a physical keyboard, stylus or other input may be used to enter the text. In one scenario, the generation of rewritten text may be initiated by user selection of an icon 126 or other user interface element. In another scenario, the system may automatically generate written text in response to identification of input text.

FIG. 1B illustrates an approach 150, in which the user uses the virtual keyboard 124 to generate the input text. In this approach, the client device 110, which includes one or more processors 152 and memory 152, has a trained machine learning model (or models) 112. The memory 154 stores the model 112, and may also store one or more personal profiles 156, which may be used in conjunction with the model 112 to generate personalized rewritten text. As shown, the client device 110 also includes one or more applications 158 (e.g., a chat app, an email app, a notepad or document writing app, etc.), a communication module 160 (e.g., to communicate with server 102 and/or other client devices), and a display module 162 configured to generate the GUI 118 including any rewritten text 116.

In this scenario, once the rewritten text is presented to the user and selected, that text can be sent to a recipient (e.g., of the chat app or email app) or saved in a document (e.g., a word editing doc, presentation, etc.). Note that in different architectures, the LLMs, rewriting corpus and trained rewriting model 112 may be maintained together, such as for comprehensive processing by a back-end server or by the client device.

### Example Systems and Methods

As noted above, one or more LLMs and trained text rewriting models may be employed in the system 100. While there are a number of different possible system configurations, they each incorporate models configured to process text. According to one aspect, models based on the Transformer architecture may be employed, although other architectures may be used. The arrangements discussed herein can utilize one or more encoders. In one scenario, a first encoder may be configured to process textual information from, e.g., user input. A second encoder may be configured to other information, such as personal profile data to aid in the personalization of the rewritten text. Alternatively or additionally, the encoders may be configured to handle audio input, multimedia input, form-based input, and/or other input modalities.

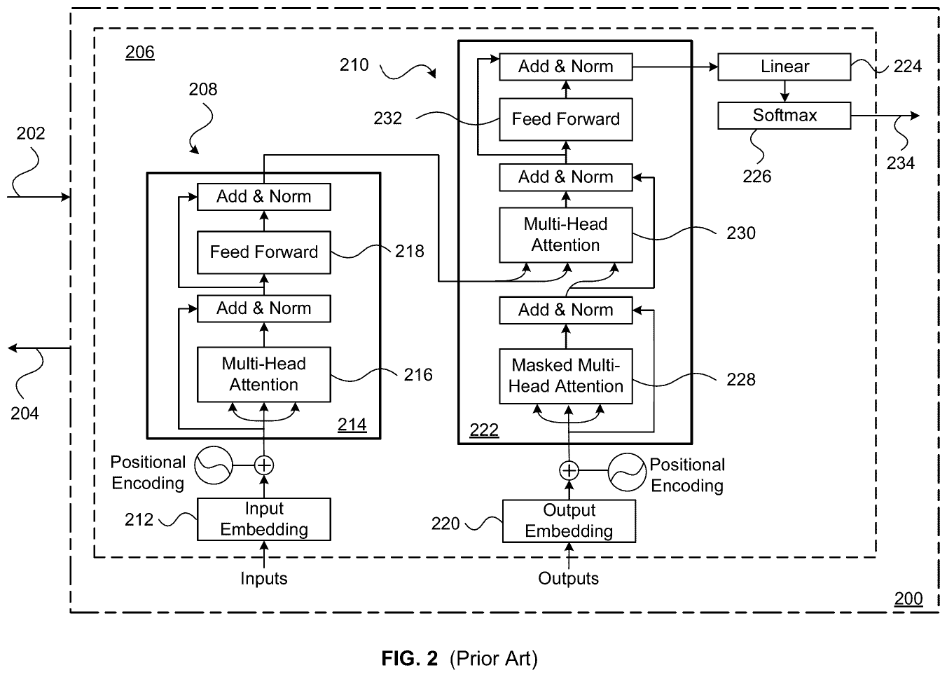

The technology described herein shows how to harness the attributes of LLMs for, e.g., caption presentation. By way of example only, a suitable Transformer architecture is presented in FIG. 2. In particular, system 200 of FIG. 2 is implementable via a computer program by processors of one or more computers in one or more locations. The system 200 receives an input sequence 202 (e.g., a query) and processes the input sequence 202 to transduce the input sequence 202 into an output sequence 204 (e.g., an answer). The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured to receive an input at the input position and apply a sequence of transformations to the input at the input position to generate an output for the input position. The inputs received by the position-wise feed-forward layer 218 can be the outputs of the normalization layer when the residual and normalization layers are included or the outputs of the encoder self-attention sub-layer 216 when the residual and normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a normalization layer that applies layer normalization to the encoder position-wise residual output. As noted above, these two layers are also collectively referred to as an “Add & Norm” operation. The outputs of this normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the normalization layer (following the last attention sub-layer in the subnetwork 222) when the residual and normalization layers are included or the outputs of the last attention sub-layer in the subnetwork 222 when the residual and normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a normalization layer that applies layer normalization to the decoder position-wise residual output. These two layers are also collectively referred to as an “Add & Norm” operation. The outputs of this normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution, to output final result 204.

According to aspects of the technology, variations on the Transformer-type architecture can be used for the models discussed herein. By way of example, these may include T5, Bidirectional Encoder Representations from Transformers (BERT), Language Model for Dialogue Applications (LaMDA), Pathways Language Mode (PaLM) and/or Multitask Unified Model (MUM) type architectures. Other types of neural network models may also be employed in different architectures.

### Smart Text Rewriting Approaches

The technology provides a new way to generate rewriting suggestions for different communication styles in different types of interactive domains, which can be used in social media or other interactive communication, as well as document preparation and editing. As noted above, in different architectures the system may implementations, in which the LLMs, trained rewriting models and rewriting corpus may be maintained in server-based and/or client device-based configurations.

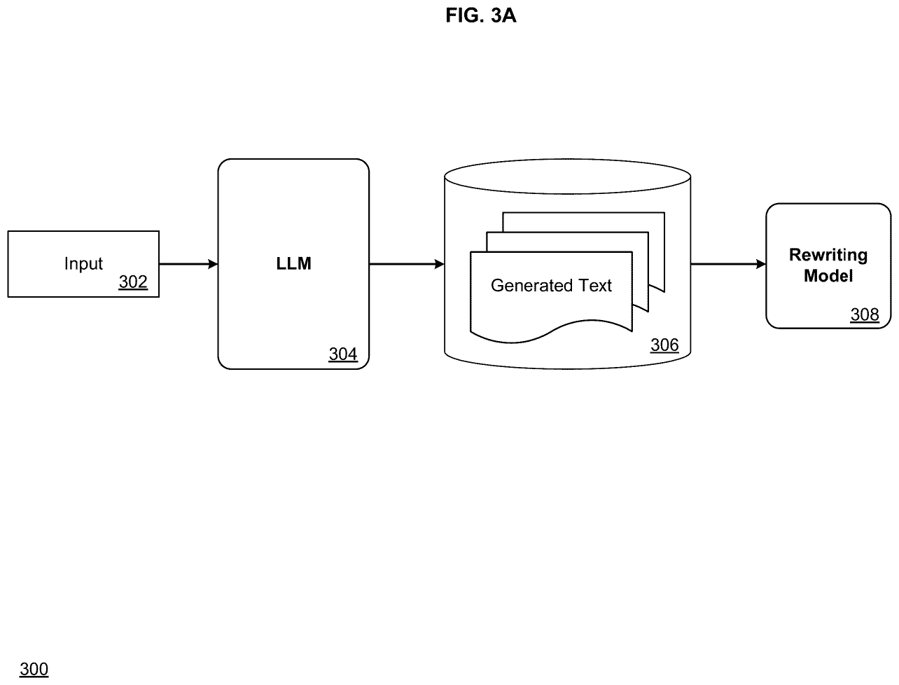

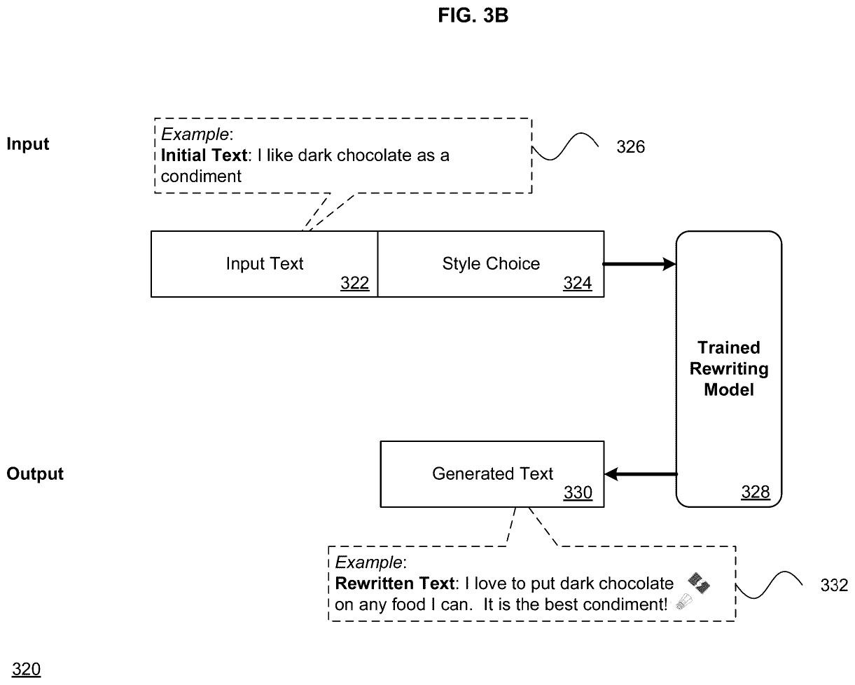

FIG. 3A illustrates an example 300 of how to train a rewriting model. As shown in this example, input 302 is provided to an LLM 304 (or multiple LLMs). The input includes a set of examples associated with one or more style choices used by the LLM to generate a large amount of generated text examples 306, which can be stored in memory as a rewriting corpus. These examples are then used to train a text rewriting model 308. In one scenario, the LLM 304 is trained using a few-shot learning approach. The text rewriting model 308 is configured to generate vivid textual and/or graphical information in response to a user query, according to specific style choices including at least one of a tone, a conversion, an application context, or a conversation type.

For instance, the input may supply only a few examples (e.g., O(10) curated examples per desired rewriting style). Thus, in one scenario, there may be on the order of 5-10 examples or no more than several dozen examples per rewriting style. In addition, the system can apply prompt tuning techniques to incorporate more examples. Prompt-tuning is an efficient, low-cost way of adapting a foundation model to new downstream tasks without retraining the whole model. It is a form of parameter efficient tuning, which only tunes a small number of runtime parameters. Prompt tuning involves storing a small task-specific prompt for respective tasks. It supports mixed-task inference using the original pre-trained model. A pre-trained foundation model can be prompt tuned to serve different tasks with different prompt-embeddings, rather than serving a separate finetuned model for every task, such as to use a LLM foundation model and prompt tune it for various style rewrite tasks, text expansion tasks, and summarization tasks. Prompt tuning also works well with small datasets. Thus, according to one aspect of the technology, a model distillation/compression approach may be employed in which the output from running a prompt-tuned LLM is used to train a more compact and efficient rewriting model, which is then used to quickly serve rewritten samples to a user. Alternatively or additionally, a mixture of experts (MoE) approach and/or a quantization approach may be used as part of the training. MoE is a type of conditional computation where parts of the network are activated on a per-example basis. It can increase model capacity without a proportional increase in computation. For instance, MoE can be used to train a Transformer-based model in accordance with the approaches discussed herein.

The rewriting corpus produced by the LLM is able to provide a significant amount of training data for the text rewriting model. By way of example, this can include thousands or millions of generated text examples corresponding to one or more style choices. Thus, the amount of system-generated training data may be several (e.g., 2-6) orders of magnitude larger than the input text (at 302 of FIG. 3A). The style choices may include, tones (e.g., casual, formal, humorous, vivid and/or exaggerated), conversions (e.g., expand on a small amount of text, abbreviate a long piece of text and/or emojify a text string), application context according to domain types, such as chat apps, social media apps, email apps, word processing or presentation apps, etc., as well conversation types (e.g., family or close friends dialogue, colleague interaction, business communication, etc.).

Once the rewriting model has been trained, it can be used to generate rewritten text segments based on user input. FIG. 3B illustrates an example 320 of this. Here, input text 322 and a style choice 324 are inputs to trained rewriting model 328. In this example, the input text is shown at 326 as “I like dark chocolate as a condiment”. The style choice may include a set of one or more styles. For instance, here the conversation type may be “close friends”, the application context may be “chat app”, the tone may be “humorous”, and a conversion type may include both “expand” and “emojify”. Generated text 330 from the model 328 is shown in example 332 as “I love to put dark chocolate on any food I can. It is the best condiment!”. In addition, because “emojify” is included as part of the style, a chocolate bar ( [symbol] ) emoji may be included as shown after the text “dark chocolate”, and a condiment shaker ( [symbol] ) may be included after the word “condiment”. In another example where the style is “polite”, if the input text is “come and sit”, the generated text may be “Please, would you come and sit?

There are different options to train the system to handle multiple styles. For instance, each training example may be in the form of (original text, style)->rewritten text. Thus, the system learns to convert any text and style pairs into rewritten text. Another is using an encoder-decoder based multitask model. In this approach, the original text is mapped into a latent representation using the trained encoder, and then for each style or conversion type, a decoder is trained to map the latent representation into the corresponding style. Alternatively or additionally, adapter-based fine-tuning may be employed. Here, the system would freeze a pre-trained LLM, but train an adapter for each style. The adapters would then be injected auxiliary parameters, e.g., low-rank adaptation (LoRA).

While only one trained rewriting model is shown in FIGS. 3A and 3B, multiple models may be trained according to the text generated by the LLM(s). For instance, individual models may be trained based on specific styles (or combinations of styles). Whether one or multiple rewriting models are used, one benefit to the above approach is that such models can be small enough to easily run on a client device or a server with a low processing device and/or low latency requirement. This allows for rapid generation of suggested text, e.g., within no more than a few second from when the input text was entered by the user.

### Personalization

Personalization of rewritten text may be particularly beneficial depending on the type of communication domain (e.g., more suitable for a humorous social media post while less suitable for a business communication sent as an email). The following present a few types of personalization scenarios. One is to adapt the writing to the usual tone of the user in open-ended prompts-based writing and rewriting. Another is to use contextual signals such as to whom the user is talking (e.g., friend or colleague), on which type of application is the text being presented (e.g., presentation or chat).

A third involves style transfer use cases, where the user may actually want to depart from their usual tone, incorporate user feedback signals (e.g., select or abandon, make manual corrections, etc.) from past examples when they check the same style. This is because even for categorized styles, there could still be a lot of nuances in tones. For example, “I'm not a fan of the DMV” and “Dealing with the DMV is a pain” can both be casual ways of saying the user does not like interacting with the DMV, but each user's preferences can, and the system can learn such preferences from past examples of the same style.

Thus, as noted in block 156 of FIG. 1B, the system may maintain information associated with one or more personal profiles (e.g., stored locally at the client device). Further to the descriptions above, a user may be provided with controls allowing the user to make an election as to both if and when systems, programs, or features described herein may enable collection of user information (e.g., information about a user's social network, social actions, or activities, profession, a user's preferences, writing or communication style, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Personalization options may depend on how the rewriting model is deployed, e.g., on the client device versus on a back-end application server. A first option for an on-device model involves fine tuning the model(s) using data from the device for personalization. By way of example, as the user uses one or more applications, the on-device model may use or flag certain text segments as personalized inputs to update or retrain the model. A second option may utilize user sign-in information to help identify suitable text segments. For example, if the user is one of several people using a shared app in real time (e.g., a videoconference with virtual whiteboard text-based input), then the sign-in information associated with that app could be used to identify when the user writes on the virtual whiteboard, in order to determine whether to use such writing for personalization.

A third option involves on-the-fly (soft) prompts. Here, instead of learning the personalization parameters from users' history data on the server, the system can explore the LLMs' capability to use prompt prefixes to influence the output during inference time. In this approach, the system can send a summary of on device data along with the task input in each request to the LLM. There are a few options for what the summary could be. For instance, one approach would be to send a few recent examples of users' writing in a similar context as the prompt prefix. Another approach would be to learn an on-device embedding model, which encodes the history data from the user(s) as soft prompt to send to the model. Another aspect of personalization that can be incorporated into the process is contextualization, e.g., adjusting the tones based on to whom the user is talking. The conversational context can also be encoded as embedding in the soft prompt sent to the model.

Regardless of the option, according to one aspect the system may embed the raw text associated with a particular user into different styles. Alternatively or additionally, the system could classify a writing style based on evaluation of raw text samples from the user.

### Emojification

As noted above, one aspect of the technology involves emojification, in which the rewritten text is automatically decorated with emojis, icons, gifs or other visual indicia. Emojification involves semantic augmentation. Different patterns of emojification can be employed, e.g., in response to a concept prediction model and/or rule-based keywork matching. The concept prediction model would classify the input text into various concepts, e.g., “awesome”, “displeasure”, “good luck”, “gift”. e.g., text “it is a good idea”->concept “awesome”, text “I don't like it”->concept “displeasure”. Then the system maps the concept to the emojis, e.g., “awesome”-> [symbol] , or “I don't like it”->®. Emojification may include one or more of: (1) using unsupervised [symbol] or semi-supervised approaches to detect salient expressive phrases, (2) using a zero-shot or few-shot learning approach to retrieve a diversified range of emojis that express sentiment and augment semantics, (3) employing logic to utilize model outputs to enable various emojify patterns, and/or (4) applying evaluation benchmarks to evaluate emojify quality.

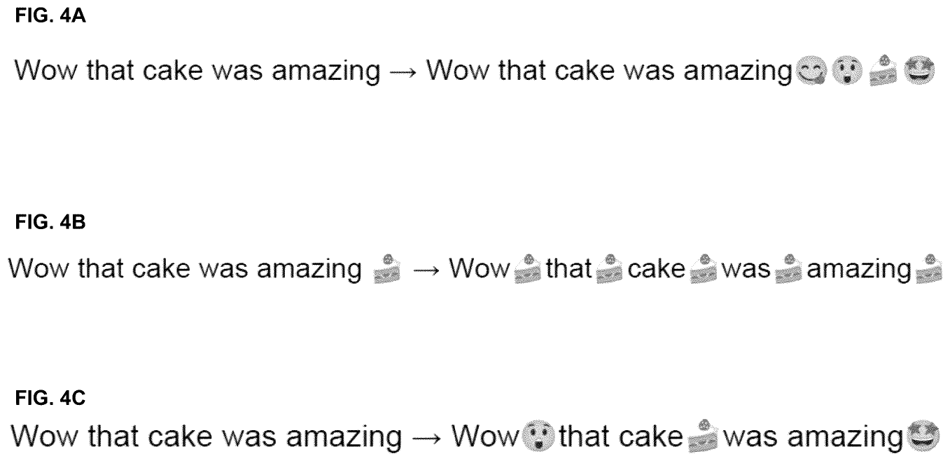

FIG. 4A illustrates one example of emojification. Here, “Wow that cake was amazing” has been modified to add a variety of relevant emojis to the end of the sentence. According to one approach, the system adds all the emojis from the following sources at the end of the original sentences. First, the system runs a concept prediction model on the whole sentence to retrieve emojis (e.g. [symbol] ). Then the system looks for keywords within the sentence and retrieve emojis if there's a predefined mapping between a keywords and emoji (e.g. “wow”-> [symbol] , “cake”-> [symbol] , “amazing”-> [symbol] ).

Alternative patterns may be used for emojification. This includes a beat pattern, an append pattern, and a heart pattern. FIG. 4B illustrates a beat pattern, which involves repeating the emoji or other visual indicia after each word (or group of words) in a sentence). FIG. 4C illustrates an append pattern, in which the relevant emoji or other visual indicia is inserted immediately following the expressive phrase or word. FIGS. 4D and 4E illustrate variants of the heart pattern, where the icons/emojis are arranged in different two-dimensional visualizations. Here, if the text relates to food such as a taco, the pattern incorporates heart shapes on one or more visual levels (e.g., an array of heart emojis arranged in a heart-shaped pattern), which as shown are interspersed with taco emojis. Thus, the different indicia (e.g., emojis) are arranged in a selected two-dimensional pattern.

According to another aspect, because emojification involves semantic augmentation, in some scenarios a sentence or other text segment may be decorated with more diversified emojis. Thus, different types of heart emojis may be presented in the heart pattern, different types of face emojis may be used to emphasize the user's love of the cake, etc.

The emojify model may be framed as a sequence labeling problem. For instance, semantic segmentation recognizes objects from a number of visual object classes in an image without pre-segmented objects, by generating pixel-wise labels of the class of the object or the class of “background”. Similarly, the task of emojifying recognizes emojis or other visual indicia in an unsegmented input sentence, and the system can generate word-level labels for what is the most relevant emoji given its context, or if there is no relevant emoji to surface. Thus, one method according to this framework includes the following modules: (1) first generate emojify annotations, and then (2) train sequence label model based on annotated emojify data.

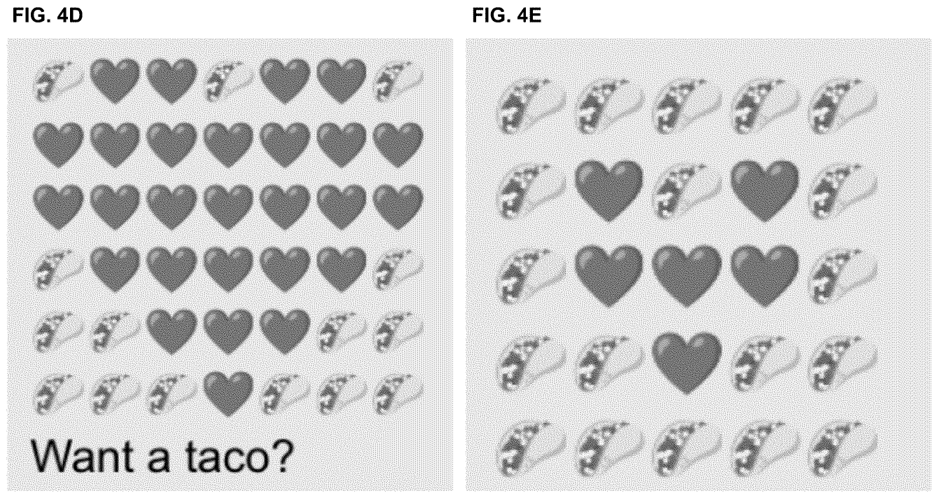

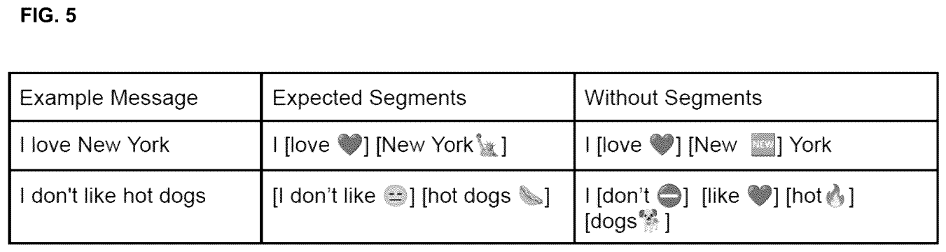

Generation of emojify annotations can be done via the following steps. First, identify expressive phrase candidates, such as by segmenting an input sentence into phrase chunks where in each phrase the words constitute the semantic meaning of the phrase as a group. Then retrieve relevant emojis (or decide if there are no relevant emojis) for each phrase, given its context in the sentence or other text segment. As part of this, the system performs phrase detection. This involves segmenting an input sentence into phrases, where in each phrase the words constitute the semantic meaning of the phrase as a whole. In other words, removing a word in the phrase would change the meaning of the phrase and lead to a different emoji annotation. An example of this is shown in FIG. 5. Phrase chunks can use a dependency parser, part-of-speech tagging, and/or entity mentions.

The dependency parser represents the syntactic structure of a sentence as a directed tree. Each node in the tree corresponds to a token in the sentence, and the tree structure is represented by dependency head and dependency label for each token. For the dependency head, each token in the tree is either the root of the tree or has exactly one incoming arc, originating at its syntactic head. For the dependency label, each token is annotated with a label indicating the kind of syntactic relationship between it and other tokens in the sentence.

The part-of-speech tagging model assigns each token in the sentence to categories such as nouns, adjectives and adverbs. They are helpful to generate finer-grained annotations, especially when the system will emojify patterns to insert emojis right after a noun, adjective or adverb. For entity mentions, the mention chunking model detects the nominal elements in a text that refer to entities, such as common nouns (e.g., “high school”) and property names (e.g., “golden gate bridge”). The entity mentions can be used to calibrate the phrase segment results to ensure the system does not break within a phrase of common nouns or property names, especially in fine-grained annotations based on part-of-speech taggings.

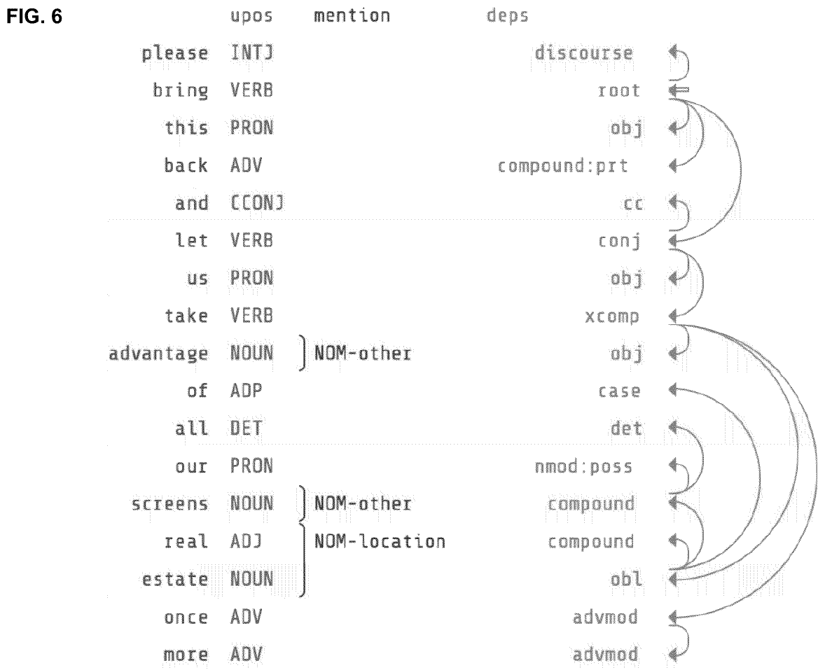

A series phrase detection procedure is described with the following example, where the input message is “please bring this back and let us take advantage of all our screens real estate once more”. This sentence's dependency parsing, part-of-speech tagging and entity mentions are as shown in the diagram illustrated in FIG. 6. For each token, find the subtree in the dependency parser tree where this token serves as the root node. Ignore subtrees that only contain the current token.

“please”: “”
“bring”: “please bring this back and let us
take advantage of all our screens real estate once
more” (if and only if the token is “root”
of the dependency parser tree, the subtree is the
full original sentence)
“this”: “”
“back”: “”
“and”: “”
“let”: “and let us take advantage of all our screens real estate once more”
“us”: “”
“take”: “take advantage of all our screens real estate once more”
“advantage”: “”
“of”: “”
“all”: “”
“our”: “”
“screens”: “all our screens”
“real”: “”
“estate”: “all our screens real estate”
“once”: “once more”
“more”: “”

For the candidate phrases returned in the above step, a shorter phrase could be part of a longer phrase, indicating the longer phrase can be further broken down into more phrases: this shorter phrase, and the rest of the longer phrase. This will result in a list of non-overlapping phrases covering the whole original sentence. Thus, the candidate phrases in the above step:

[“please bring this back and let us take advantage
of all our screens real estate once more”,
“and let us take advantage of all our screens real
estate once more”, “take advantage of all
our screens real estate once more”, “all our screens”,
“all our screens real estate”, “once
more”]

Results from further breaking down are as follows:

[“please bring this back”, “and let us”,
“take advantage of”, “all our screens”, “real estate”,
“once more”]

The process then involves separating out tokens with a particular dependency label (e.g., “discourse”). In this scenario, a discourse label is defined as a token which is not clearly linked to the structure of the sentence, except in an expressive way. Such a definition indicates that the token should be separated as an independent phrase for emoji retrieval. For instance:

[“please bring this back”, “and let us”,
“take advantage of”, “all our screens”, “real estate”,
“once more”] → [“please”, “bring this back”,
“and let us”, “take advantage of”, “all our
screens”, “real estate”, “once more”]

The above steps segment an input message into phrases, where the words in each phrase are structurally linked. However sometimes the segmented phrases could be too coarse: e.g., “hopefully someone will take them off my hands”→[“hopefully someone will take them”, “off my hands” ]. In this case, it would be good to show a [symbol] right after “hopefully”.

For phrases longer than K tokens, the system can perform the following further steps to break them down. First, identify tokens with part-of-speech tags NOUN, ADJ, ADV, VERB. Then check if those tokens are breaking any detected entity mentions. And then further break down the phrase by non-breaking tokens. For instance: “hopefully someone will take them” 4 [“hopefully”, “someone will take”, “them” ]. Here, when K=1, this retrieves emojis for every word with specified part-of-speech tags that do not break detected entity mentions.

Emoji retrieval involves finding relevant emojis for segmented phrases, or decide if there are no relevant emojis for a phrase. There are several emoji prediction/retrieval models that can be used to generate emoji annotations. The system may fuse the knowledge from different models to improve retrieval quality. By way of example, the different models may include (1) a Sentence Embedding based Emoji Retrieval Model, (2) a Diversified Emoji Prediction Model, and (3) an Emotion-based Emoji Prediction Model.

The sentence embedding based emoji retrieval model uses sentence embedding to search for keywords that are relevant to an input phrase, and retrieves emojis associated with the retrieved keywords. An advantage of this approach is that it can discover novel emoji usage, by linking emojis to text of induced meanings, e.g., “I ordered it [symbol] ”, since [symbol] has keyword “delivery”. However, the precision may be sensitive to emoji keywords accuracies and coverage, e.g., “what they care about [symbol] ”, since [symbol] has keyword “care”. Also, phrases with similar pattern but opposite sentiments can have high similarity, e.g., e.g., “but they don't like us [symbol] ”.

With the diversified emoji prediction model, the system can also train an emoji prediction model predicting over both emotional and entity emojis, diversifying the prediction results by performing a downsampling based on emoji frequencies. By way of example, the system can employ a fine-tuned BERT model on the downsampled hangout dataset and compare it with the sentence embedding model. Advantages of this model include that it can discover new emoji meanings by mining conversational data, e.g., “major [symbol] ”, “generous [symbol] ”, and also that it can be more accurate when the sentence embedding model is sensitive to keyword accuracies, e.g., what they care about [symbol] . However, the model precision may be imbalanced for different emojis, and some emojis may get over triggered (recall significantly higher than precision). Also sometimes emojis are predicted as next words, instead of summarizing the prior text, e.g., “I want [symbol] ”.

Based on the analysis above, retrieving emojis using sentence embeddings trained in self-supervised manner and predefined set of emoji-keyword mapping can identify relevant emojis in many cases and discover novel emoji usage. The system can improve the emoji retrieval results by incorporating the diversified emoji prediction model with the following steps: improving the emoji-keyword set, and using the emoji prediction model to check sentiment consistency. For improving the emoji-keyword set, a the diversified emoji prediction model can discover emoji meanings from conversational data, it can be used to expand emoji keywords, and identify more relevant emojis for existing keywords. In testing, the system used the BERT-based diversified emoji prediction model on 18 k unigrams (used as vocabulary in concept prediction model). Around 5 k of these unigrams had emoji pb keywords. In seeking to identify emojis that reflect the semantic meanings (v.s. sentiments) of a word, the system retrieves the most relevant emojis for each word by combining the results of the diversified emoji prediction model and sentence embedding model. More specifically, for a given potential keyword w, run diversified emoji prediction for top K predicted emojis {e1, e2, . . . , eK}. For each emoji eᵢ in {e₁, e₂, . . . , e_{K}}, compute the semantic similarity scores between w and each existing keywords of ₑᵢ, and compute the highest score score_i among these similarity scores. Then retrieve the most relevant emoji for w as eᵢ with the highest score_i among {e₁, e₂, . . . , e_{K}}. When this was performed during testing, the retrieved emojis were manually reviewed and ˜9 k words and their most relevant emojis were identified.

This approach may be further improved for keywords discovery by (1) scaling up the diversified emoji prediction model utilizing larger pretrained models, such as Lamda or MUM, for better prediction accuracy, and (2) applying the method to ngrams.

Phrases with similar pattern but opposite sentiments can have high similarity. Furthermore, the segmented phrase may not be sufficient to reflect the sentiment of all preceding text; e.g., for “[not feeling][super optimistic]”, “super optimistic” would correspond to an emoji of positive sentiment; however the whole preceding text should correspond to an emoji of negative sentiment. The system can utilize the emoji prediction model to check if the emojis retrieved based on a segmented phrase with sentence embedding model is consistent with the sentiment of full preceding text. For example, while sentence embedding model retrieves [symbol] for “super optimistic”, the emoji prediction model for “not feeling super optimistic” predicts [symbol] . As [symbol] is in predefined list of emojis of positive sentiment, while [symbol] is in predefined list of emojis of negative sentiment, the system would decide to use the result from emoji prediction model to correct the sentiment mismatch: “not feeling [symbol] super optimistic [symbol] ”→“not feeling [symbol] super optimistic [symbol] ”.

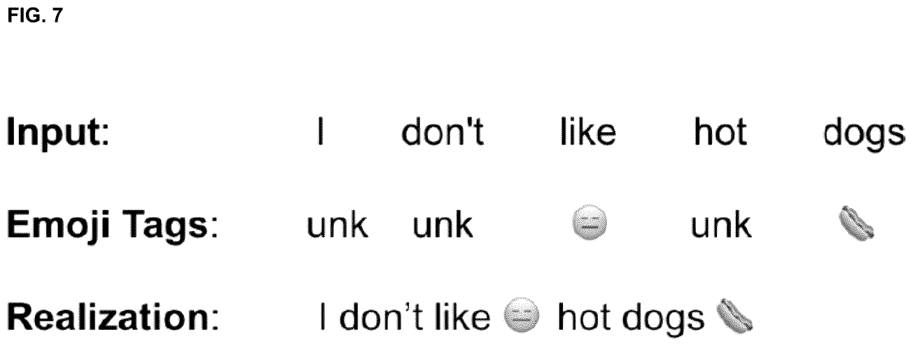

When performing emojification, the output text should recover the original input text, with relevant emoji(s) inserted after corresponding words. In this setting, learning a sequence to sequence model to generate the output text from scratch would be intuitively wasteful as a lot of the effort is recovering the original text. Therefore, problem may be addressed as a sequence labeling task. Sequence labeling (or sequence tagging) is the task that assigns categorical labels to each element in a sequence. Common sequence labeling tasks include name-entity extraction, part-of-speech tagging and image segmentation. In emojification herein, for each word the system may assign it to the relevant emoji to be inserted after it, or decide if no emoji should be assigned. FIG. 7 illustrates an example of input text (here, “I don't like hot dogs”), identified emoji tags (where “unk” means unknown), and a realization of the rewritten text with the emojis. Note that the emoji tags depend on both the preceding and following text. In the example of FIG. 7, without the preceding context “I don't”, “like” would be assigned to positive emojis instead of [symbol] ; without the succeeding text “dogs”, “hot” could be assigned to [symbol] .

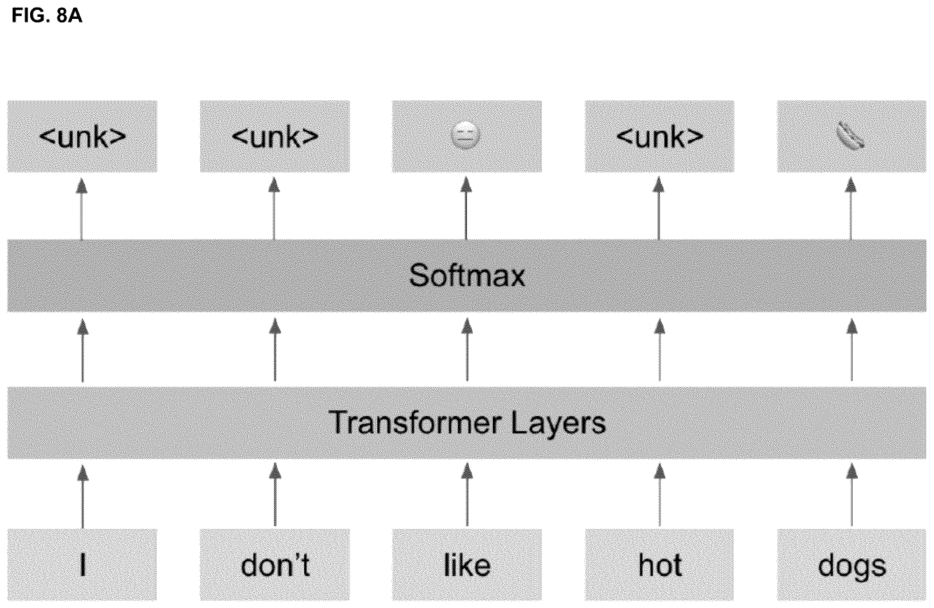

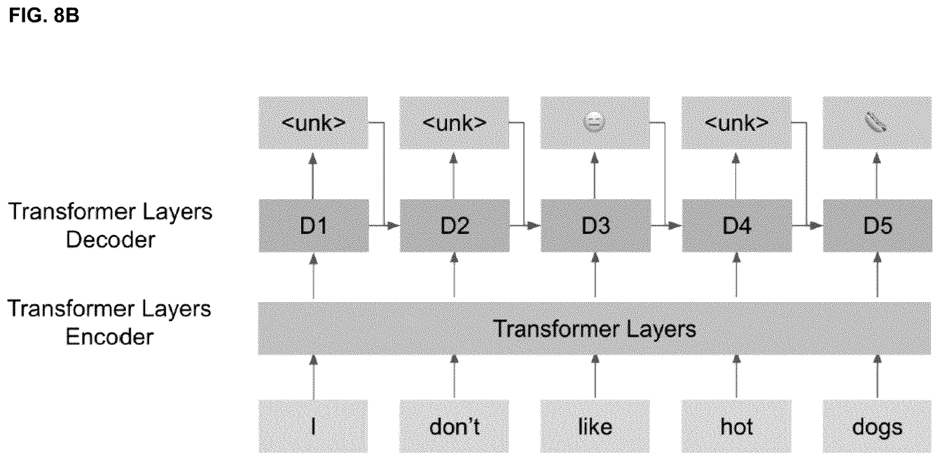

Transformer-based taggers may be utilized as model architectures for sequence labeling tasks. One baseline sequence tagging model architecture is shown in FIG. 8A. This baseline model directly generates emoji tags in a single feed-forward pass by applying an argmax over the logits from neural network layers. In this model, each output tag is predicted independently, without modeling the dependencies between the predicted tags in the sequence. However, some sequence labeling tasks such as Name Entity Recognition may achieve good performance with this simple framework.

Another model architecture is the encoder-decoder model, which is shown in FIG. 8B. Here, to better capture the dependencies between the predicted tag labels, a transformer decoder layerer could consume the embedding of the previously predicted label and the activations from the transformer encoder layers. An example discussion of this architecture can be found in “Encode, Tag, Realize: High-Precision Text Editing” by Malmi et al., Sep. 3, 2019, the entire disclosure of which is incorporated herein by reference.

### Model Evaluation Criteria

According to an aspect of the technology, the utility of a given rewriting model may be evaluated according to a set of criteria. This can include one or more of (1) content preservation, (2) factual consistency, (3) fluency), (4) coherence) and/or (5) style accuracy. Content preservation evaluation judges whether the semantic meaning of the rewritten text is similar to that of the input text. Factual consistency evaluation judges whether the written text is true to the intent of the text. This can include identification of any hallucination or contradictory statement in the rewritten text. Fluency evaluation judges whether the output is as natural and attractive to read as possible. Coherence evaluation judges whether the text is easy to understand. And style accuracy evaluation may judge whether the system output meets the required styles/tones, regardless of whether the content of the output is accurate. A filter may be applied to identify and address hallucinations or improper words (e.g., curse words) in the proposed text. This filter may be integrated into the text rewriting model or may be part of a post-processing stage before the generated text is sent by the system for presentation on a display device (or before audio of the text is played to the user).

### Example Computing Architecture

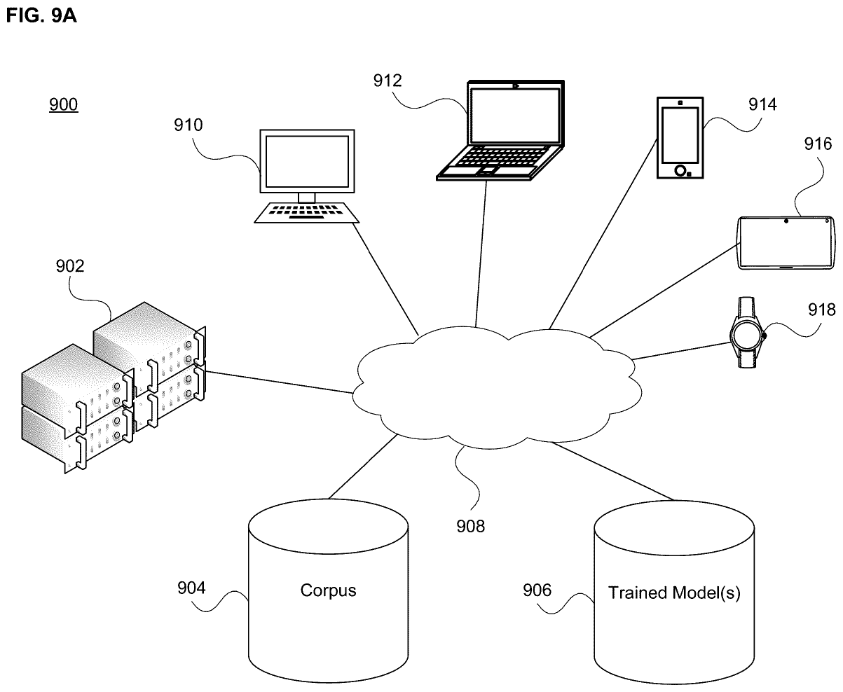

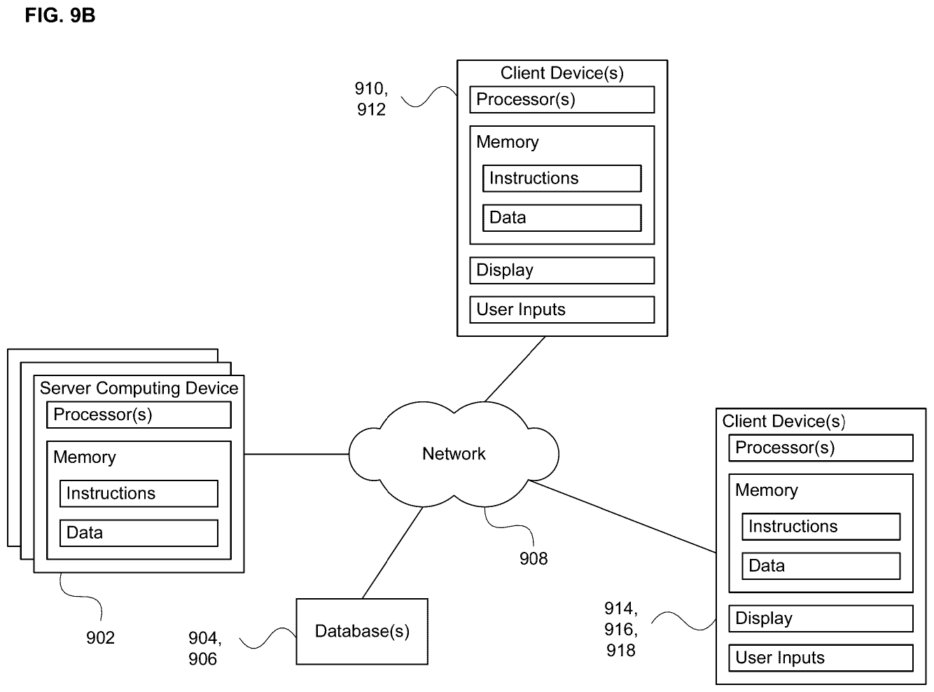

The rewriting technology discussed herein may be trained and generate rewritten text based on received queries on one or more tensor processing units (TPUs), CPUs or other computing in accordance with the features disclosed herein. One example computing architecture is shown in FIGS. 9A and 9B. In particular, FIGS. 9A and 9B are pictorial and functional diagrams, respectively, of an example system 900 that includes a plurality of computing devices and databases connected via a network. For instance, computing device(s) 902 may be implemented as a cloud-based server system. Databases 904, and 906 may store, e.g., a corpus of rewriting information and/or trained models (including LLMs and the rewriting model(s)), respectively. The server system may access the databases via network 808. Client devices may include one or more of a desktop computer 910 and a laptop or tablet PC 912, for instance that present a particular caption or other text from a user, and/or to view the rewritten text variations provided by the system in accordance with a given neural network arrangement as discussed here, which could be provided to the user via a web-based service, app or other program. Other client devices may include handheld devices including a personal communication device such as a mobile phone or PDA 914 or a tablet 916. Another example is a wearable device 918 such as a smartwatch (or head-mounted display device).

As shown in FIG. 9B, each of the computing devices 902 and 910-918 may include one or more processors, memory, data and instructions. The memory stores information accessible by the one or more processors, including instructions and data (e.g., models) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphical processing units (GPUs), etc. Alternatively, each processor may be a dedicated device such as an ASIC or other hardware-based processor. Although FIG. 9B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 902. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, audio, and imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related computing devices (e.g., 910-918) may communicate with a back-end computing system (e.g., server 902) via one or more networks, such as network 908. The network 908, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 902 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 902 may include one or more server computing devices that are capable of communicating with any of the computing devices 910-918 via the network 908. The computing device 902 may implement a back-end server (e.g., a cloud-based image caption server), which receives information from desktop computer 910, laptop/tablet PC 912, mobile phone or PDA 914, tablet 916 or wearable device 918 such as a smartwatch or head-mounted display.

As noted above, the application used by the user, such as a word processing, social media or messaging application, may utilize the technology by making a call to an API for a service that uses the LLM to provide the text segments. The service may be locally hosted on the client device such as any of client devices 810, 912, 914, 916 and/or 918, or remotely hosted such as by a back-end server such as computing device 902. In one scenario, the client device may provide the textual information but relies on a separate service for the LLMs and the trained text rewriting model. In another scenario, the client application and the models may be provided by the same entity but associated with different services. In a further scenario, a client application may integrate with a third-party service for the baseline functionality of the application. And in another scenario, a third party or the client application may use a different service for the LLMs and/or text rewriting model(s). Thus, one or more neural network models may be provided by various entities, including an entity that also provides the client application, a back-end service that can support different applications, or an entity that provides such models for use by different services and/or applications.

Resultant information (e.g., one or more sets of rewritten text, with or without emojification) or other data derived from the approaches discussed herein may be shared by the server with one or more of the client computing devices. Alternatively or additionally, the client device(s) may maintain their own databases, models, etc. Thus, the client device(s) may locally process text for rewriting in accordance with the approaches discussed hereon. Moreover, the client device(s) may receive updated rewriting models (and/or LLMs) from the computing device 902 or directly from database 906 via the network 908.

### Exemplary Method

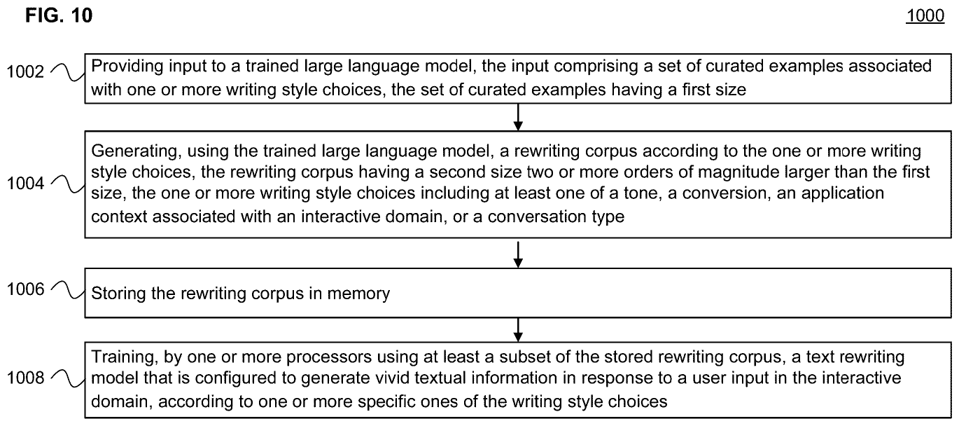

FIG. 10 illustrates an exemplary method 1000 for a system in view of the above discussion. At block 1002, the method includes providing input to a trained large language model. The input comprises a set of curated examples associated with one or more writing style choices, in which the set of curated examples has a first size. At block 1004, the method includes generating, using the trained large language model, a rewriting corpus according to the one or more writing style choices. The rewriting corpus has a second size two or more orders of magnitude larger than the first size. The one or more writing style choices include at least one of a tone, a conversion, an application context associated with an interactive domain, or a conversation type. At block 1006 the method includes storing the rewriting corpus in memory. And at block 1008, the method includes training, by one or more processors using at least a subset of the stored rewriting corpus, a text rewriting model that is configured to generate vivid textual information in response to a user input in the interactive domain, according to one or more specific ones of the writing style choices.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method, comprising:
providing input to a trained large language model, the input comprising a set of curated examples associated with one or more writing style choices, the set of curated examples having a first size;
generating, using the trained large language model, a rewriting corpus according to the one or more writing style choices, the rewriting corpus having a second size two or more orders of magnitude larger than the first size, the one or more writing style choices including at least one of a tone, a conversion, an application context associated with an interactive domain, or a conversation type;
storing the rewriting corpus in memory; and
training, by one or more processors using at least a subset of the stored rewriting corpus, a text rewriting model that is configured to generate vivid textual information in response to a user input in the interactive domain, according to one or more specific ones of the writing style choices.

2. The method of claim 1, wherein training the text rewriting model includes personalization according to one or more personalized inputs associated with at least one user profile.

3. The method of claim 2, wherein the training comprises updating a baseline version of the text rewriting model using the one or more personalized inputs as additional training data for the text rewriting model.

4. The method of claim 2, wherein the one or more personalized inputs includes conversational context information about a conversation a user has with another person.

5. The method of claim 1, wherein the tone includes at least one of casual, formal, humorous, vivid or exaggerated.

6. The method of claim 1, wherein the conversion includes one of expand an initial amount of text from the user input, abbreviate the initial amount of text, or emojify a text string from the user input.

7. The method of claim 1, where the application context is associated with a chat domain, a social media domain, an email domain, a word processing domain or a presentation domain.

8. The method of claim 1, wherein the conversation type is one of a family conversation, a friends conversation, a dialogue, a colleague interaction, or a business communication.

9. The method of claim 1, wherein the text rewriting model is further trained to generate graphical indicia to emojify the vivid textual information.

10. The method of claim 9, wherein the trained text rewriting model is configured to generate one or more patterns of the graphical indicia in response to a concept prediction model or rule-based keyword matching.

11. The method of claim 9, wherein emojification of the vivid textual information is performed according to:
using an unsupervised or a semi-supervised approach to detect salient expressive phrases;
using a zero-shot or a few-shot learning approach to retrieve a diversified range of emojis that express sentiment and augment semantics;
employing logic to utilize model outputs to enable various emojify patterns; or
applying evaluation benchmarks to evaluate emojify quality.

12. The method of claim 9, wherein the trained text rewriting model is configured to generate one or more patterns of the graphical indicia, the one or more patterns including a beat pattern or an append pattern.

13. The method of claim 9, wherein the trained text rewriting model is configured to generate a two-dimensional visualization pattern including at least one emoji or other graphical indicia.

14. The method of claim 9, wherein the graphical indicia to emojify the vivid textual information is generated with semantic augmentation.

15. The method of claim 9, wherein training the text rewriting model to generate the graphical indicia includes generating a set of emojify annotations, and then training the text rewriting model based on the set of emojify annotations.

16. The method of claim 15, wherein generating the set of emojify annotations includes identifying expressive phrase candidates, and then retrieving relevant emojis or other or other graphical indicia for each expressive phrase candidate given the candidate's context in a text segment.

17. A computing system, comprising:
memory configured to store a rewriting corpus; and
one or more processors operatively coupled to the memory, the one or more processors being configured to:
provide input to a trained large language model, the input comprising a set of curated examples associated with one or more writing style choices, the set of curated examples having a first size;
generate, using the trained large language model, the rewriting corpus according to the one or more writing style choices, the rewriting corpus having a second size two or more orders of magnitude larger than the first size, the one or more writing style choices including at least one of a tone, a conversion, an application context associated with an interactive domain, or a conversation type;
store the rewriting corpus in memory; and
train, using at least a subset of the stored rewriting corpus, a text rewriting model that is configured to generate vivid textual information in response to a user input in the interactive domain, according to one or more specific ones of the writing style choices.

18. The computing system of claim 17, wherein training the text rewriting model includes personalization according to one or more personalized inputs associated with at least one user profile.

19. The computing system of claim 18, wherein the training comprises updating a baseline version of the text rewriting model using the one or more personalized inputs as additional training data for the text rewriting model.

20. The computing system of claim 17, wherein the text rewriting model is further trained to generate graphical indicia to emojify the vivid textual information.
